(19) United States
(12) Patent Application Publication
(10) Pub. No.: US 2005/0004852 A1
(43) Pub. Date: Jan. 6, 2005

(54) System, method and computer medium for trading interface

(76) Inventor: Scott M. Whitney, San Rafael, CA (US)

Correspondence Address: Scott M. Whitney, 9 1/2 F Street, San Rafael, CA, 94901, US

(21) Appl. No.: 10/613,515

(22) Filed: Jul. 3, 2003

(51) Int. Cl. G06F 17/60

(52) U.S. Cl. 705/35

(57) ABSTRACT

What is disclosed is a computer-implemented method for generating a right transfer instruction regarding a transferable right in a priced item. The process includes the steps of graphically presenting a chart of a price of the priced item versus time; and setting a trigger control overlaid on the chart that is responsive to the price to initiate the right transfer instruction when the price reaches a predetermined relationship to a particular price for the priced item. An apparatus includes a communications system for receiving and processing a series of price-indicators for one or more priced items; a presentation system for displaying the series of price-indicators in a graphic format; and a controller, coupled to the communications system, for overlaying one or more interface controls on the series of price-indicators, the controller responsive to user input instructions directed to the one or more overlaying controls for setting a parameter of the one or more controls and for initiating a right transfer process when one or more of price-indicators has a predetermined relationship to the parameter of the one or more controls. An article of manufacture, comprising a program storage medium readable by a computer and embodying one or more instructions executable by the computer for generating a right transfer instruction regarding a transferable right in a priced item presented by the computer, the computer having a computer program application that displays a graphical representation of price history of the priced item, the program storage medium including computer code including I/O access commands, wherein: computer program code presenting graphically a chart of a price of the priced item versus time; and setting a trigger control, using the I/O access commands, overlaid on the chart that is responsive to the price to initiate the right transfer instruction when the price reaches a predetermined relationship to a particular price for the priced item.

### BACKGROUND OF THE INVENTION

The present invention relates to computer controlled graphical user interfaces and particularly to ease of use interactive computer controlled display interfaces for effecting the purchase and sale of items having a time varying price. More particularly, it relates to computer software and hardware by which an operator visualizes a time varying price of a “thing” and manipulates controls integrated into the visualization for influencing right transfers in the “thing” responsive, at least partially, to the current price.

For many years the trading of shares listed on a stock exchange were effected by the activities of people known as traders on the trading floor of a stock exchange, and were confirmed by some form of notation or writing on paper. Once effected, the trades or transfers of shares were formally reported to brokers for the purchasing and selling customers in a formal way with or without the delivery of the share certificates.

More recently the transactions have become automated so that a trader operating a keyboard (to enter the necessary commands into a terminal connected to the mainframe computer of the stock exchange) or operating a small personal computer with a terminal emulator may do trades. With this automated system a trader may enter an order to buy or sell which is transmitted to the central system of the stock exchange where it matched with another trader who is willing to sell or buy the same shares, and the computer then confirms the completion of the transaction to each trader, and the transaction is confirmed and recorded by means of a hard copy generated on a printer.

Although this computerized automated system was much faster than the trading floor, it still required a trader to key in by hand the necessary data and commands for each individual stock being traded. From the information available at a terminal, the trader/operator would have to input the symbol for the company shares, the price, the exchange, the size of the order, and the instructions to buy, sell, cross or short trade the stock. It has even become possible to effect trades in certain stocks automatically when they reach a certain price level.

With the early type trading systems, a stock purchaser typically bought a stock for long-term investment. Therefore, the speed at which the stock purchaser evaluated the various available issues, made a decision with regard to trade in a selected issue, and communicated the decision to a broker for execution was not particularly important in the final analysis. What was more important was making the right decision.

As interest in the trading of stocks increased, and systems developed to enable quicker evaluation, decision-making, and trade instruction communication, it became increasingly common for purchasers to make short-term investment decisions.

This phenomenon continued to the point where it is common to have a “day trader” make numerous trades (sometimes hundreds or thousands of trades) in one or more issues throughout a single trading session. These day traders need to quickly assimilate relevant data for an issue of interest, decide on the desired positions of one or more issues, and communicate those decisions quickly. Small differences in the price of an issue upon both the buying and selling end often determine whether a profit was made on the transaction.

Systems of processing, synthesizing and visualizing large amounts of data were created and developed to provide the day trader with tools for more quickly evaluating an issue of interest, deciding on desired position(s) for one or more issues, and communicating those decisions for execution. The common tools are two discrete processes: a charting process, and an order execution process. The charting process presents time-varying data of a stock on a two-dimensional graph. A horizontal axis is time, and the vertical axis is price. Usually the current price is indicated on the right-most side of the graph with price information from the past presented to the left of the current price. These charting applications can be quite sophisticated and condense large amounts of price information into easily understood symbols and data. By use of such applications, the trader is able to quickly evaluate any issue graphed by the charting process. These charting applications have helped to quickly evaluate issues and make decisions for establishing positions at desired prices.

The second process includes communicating the decision(s) to a broker for execution. The order execution process is a separate process from the charting process and frequently presents an interface like a spreadsheet or “cell array.” This format, and its variations, have become the commonly used tool for quickly communicating trade orders. Columns of the array correspond to various parameters of a single trade. For example, a symbol, a price, a quantity, and a market purchase instruction are commonly used. Each row of the array identifies a separate trade.

A trader needs to quickly transfer information from the graph and complete the columns of each row before the desired trades may be initiated. Therefore, these cell-interfaces have evolved to make data entry quicker and less prone to operator error. Some macro/scripting may be used, and some systems provide for limited interaction of trades presented on the various rows.

US Application 2003/0023542 (“Click Based Trading With Intuitive Grid Display of Market Depth” teaches reduction of a time for placing trades in an electronic environment.

U.S. Pat. No. 5,339,392 (“Apparatus And Method For Creation Of A User Definable Video Displayed Document Showing Changes In Real Time Data”) teaches automated trading using scripts.

US Patent Application 2003/0009411 (“Interactive Grid-Based Graphical Trading System For Real Time Security Trading”) teaches grid-based graphical trading.

US Patent Application 2003/0004853 (“Graphical Front End System For Real Time Security Trading”) teaches a tabbed-display facilitating rapid trading.

US Patent Application 2003/0041000 (“System And Method For Providing A Graphical User Interface For A Multi-Interface Financial Transaction System”) teaches a system for viewing and executing trades on multiple Inter-dealer broker electronic trading systems.

U.S. Pat. No. 6,134,535 (“Computerized Stock Exchange Trading System Automatically Formatting Orders From A Spreadsheet To An Order Entry System”) teaches use of a graphical user interface in with a mouse and a display is used to select parameters to launch a trading order to the order entry system of a stock exchange computer.

US Patent Application 2002/0120551 A1 (“Visual-Kinesthetic Interactive Trading System”) teaches presentation of both a charting process and a trade execution process on a single display, with the single display divided into two sub-displays: one for the charting process and one for the trade execution process. The display is responsive to user operation to speed up the entry of data into the trade execution process. The abstract states that interaction with graphical information on the screen can control the trading software.

All these systems have a drawback in being relatively slow and potentially inaccurate in implementing a desired trade strategy (deduced from watching the charting process). The patents and patent applications are hereby expressly incorporated by reference for all purposes.

As the data analysis and sophistication of a day trader increases, trading strategies sometimes also increase in complexity. While a trader may desire to enter a position with defined multiple exits and multiple stops, the complexity and relative time-intensive nature of the necessary tasks for entering multiple trades into the trade execution process may discourage the trader from implementing the complete desired strategy at the time of the initial entry. A trader may try to make a series of trades in an attempt to emulate the desired strategy, but price fluctuations occurring during the time from the initial purchase to entering the final instruction may obviate the entire strategy. As a consequence, the trader may focus on micromanaging a trade (i.e., invest a relatively significant amount of effort getting the entry at the correct price, then investing more effort getting the exit at the correct price and then maybe have time to invest still more effort to position a stop loss at a desired price.)

A drawback of micromanagement is that while a trader is focusing on the tactics of entering and exiting a position, the trader is unable to implement a desired strategy in the trades, and the more time invested in a single trade means that the trader may not be able to properly monitor existing trades or evaluate other issues for additional opportunities.

Further, the micromanagement and interface limitations may also inhibit a trader's ability to maintain a desired trade discipline of always having an exit and stop for each initiated trade.

What is needed is a system, method and computer-readable medium that enhances a trader's ability to quickly translate a complex trading strategy and/or a desired trading discipline into an executable set of trade instructions.

### SUMMARY OF THE INVENTION

What is disclosed is a computer-implemented method for generating a right transfer instruction regarding a transferable right in a priced item. The process includes the steps of graphically presenting a chart of a price of the priced item versus time; and setting a trigger control overlaid on the chart that is responsive to the price to initiate the right transfer instruction when the price reaches a predetermined relationship to a particular price for the priced item. An apparatus includes a communications system for receiving and processing a series of price-indicators for one or more priced items; a presentation system for displaying the series of price-indicators in a graphic format; and a controller, coupled to the communications system, for overlaying one or more interface controls on the series of price-indicators, the controller responsive to user input instructions directed to the one or more overlaying controls for setting a parameter of the one or more controls and for initiating a right transfer process when one or more of price-indicators has a predetermined relationship to the parameter of the one or more controls. An article of manufacture, comprising a program storage medium readable by a computer and embodying one or more instructions executable by the computer for generating a right transfer instruction regarding a transferable right in a priced item presented by the computer, the computer having a computer program application that displays a graphical representation of price history of the priced item, the program storage medium including computer code including I/O access commands, wherein: computer program code presenting graphically a chart of a price of the priced item versus time; and setting a trigger control, using the I/O access commands, overlaid on the chart that is responsive to the price to initiate the right transfer instruction when the price reaches a predetermined relationship to a particular price for the priced item.

It is a feature of the priced-right transfer interface to provide context sensitive labels and tools embedded in an active region of a chart surface. By operating an I/O system of a computer system to give an element focus (e.g., using a mouse to control a cursor and clicking a mouse button when the cursor overlies an element) an element, that element is ‘hot’ or live for user input. Either by dragging the cursor or rolling the mouse wheel, or in some implementations, operating keys associated with a keyboard, the values change. Greatly reduced is any need to manually type in a value or select a value from a drop down list on a secondary display, or transfer those values from other data source used to identify and select desired items, if any such typing, selecting or transferring is necessary at all.

Giving focus to a Order control line makes the line ‘Hot’. Rolling the mouse wheel up or down and/or dragging the mouse cursor across the chart surface and the price for that Order line changes, the line moves on the chart to reflect the changed price, and scaled to the displayed price. The profit of that Order line as well as the entire Trade is recalculated instantaneously. All associated elements of that Order may move with the line; such as trailing stops, and auxiliary slip levels. Adjacent order lines part of the complex trade object also move if required.

Clicking certain controls brings focus to them allowing the user to roll the mouse wheel to change the values. An example is the Order Type Label control. By simply clicking on the label and rolling the mouse wheel, the user cycles or loops through the available Order types, for example Market, Limit, Limit Slip, and Limit Trigger for a stock-related interface 300.

A powerful feature of the priced-right transfer interface is use of size label controls. By clicking a particular size label control (or group of controls) and giving it/them focus, the user is able to not only change the size or quantity of that particular Order line, the user may ‘spray out’ additional Entry and Exit Orders, and manipulate those Order sizes in balance with the entire Trade. The interface provides a powerful tool to users to rapidly create and deploy multiple Entry and Exit Orders. The new Orders inherit the default characteristics of the parent Trade Object. Literally one click and one flip of the mouse wheel will build a Complex Trade Object ready for deployment. When the user wants to reduce the Exit quantity or size, clicking and rolling the mouse down will ‘pull back’ the outlying Orders first in size, then finally as they roll through to zero they are extinguished from the Trade Object. The interface makes rights transfer a simple, rapid, powerful, responsive and intuitive operation.

The interface also easily brings Time as an argument into the Trading process. Vertical Time-In and Time-Out lines may be displayed on the chart, and through dragging or rolling, the values may be changed. It's rapid, intuitive and accurate, and visually presented in proper context.

The interface provides Trailing Stops; one for each Order line When desired. The Stops like all elements exists embedded in the Chart Display. Clicking, dragging and rolling quickly set the Trailing Stops. The interface also empowers its users with a ‘Favorites’ management tool. Create Trades, Save Trades, and assign them to a tool bar button. One click loads the Trade and populates the display interface. The interface provides a user with an ability to assign whether a new Trade Object tracks, trails or leads a current market price.

Information contained in and gathered by Complex Trade Objects is not wasted by the interface. Once a trade is set ‘Active Waiting’ or sent to a market as a ‘Snap To Market’ block, Events related to that Object are recorded and displayed in an event panel. Every aspect of the Trade and market is monitored and may be stored and evaluated when desired.

This Event panel is able to display virtually every aspect and event of the Trade as it occurs when the user desires. Simply select ‘Filter None’, and the normal user filter choices are ignored an all information flows into the event panel, and eventually to the Journal Object for storage. This Journal is able to be appended as desired by the user; before, during and after the Trade. A small and handy input window is available for making Trade notes and sending them to the Journal. The full featured Journal viewer does not need to be opened to add notes to the Journal.

Users of the interface may also elect to save the chart data associated with a Trade. The entire block of bar data for the duration of the Trade, plus margins of data before and after the Trade is scraped up and stored away with the Journal Object. This allows the user to view at anytime offline the entire Trade in context with chart data.

A Journal File Browser provides a user with an ability to re-populate a chart display object with the historic data of the market, optionally overlaid with relevant Trade Objects. The events in historic time demarcate themselves on the chart as vertical lines with notes and tags.

The interface permits easy creation and evaluation of financial reports; whether annually, quarterly or weekly. Search and sort and produce reports by any valid property value or combination of property values saved. The interface permits creation of custom reports that may be saved as defaults or as templates.

The system, method and computer-readable medium enhances a purchaser's ability to quickly translate a complex purchasing strategy and/or a desired purchasing discipline into an executable set of right transfer instructions. These and other novel aspects of the present invention will be apparent to those of ordinary skill in the art upon review of the drawings and the remaining portions of the specification.

### BRIEF DESCRIPTION OF THE DRAWINGS

FIG. 1 is a computer system that functions as a basic computer in implementing the present invention for enhancing a purchaser's ability to quickly translate a complex purchasing strategy and/or a desired purchasing discipline into an executable set of right transfer instructions;

FIG. 2 is a generalized diagram of a rights transfer system using the computing system including an embodiment of the present invention;

FIG. 3 is a representation of an graphical user interface illustrating a preferred embodiment of the present invention;

FIG. 4 is a detailed view of a header bar;

FIG. 5 is a detailed view of an execution bar;

FIG. 6 is a detailed view of a set of interface tool controls;

FIG. 7 is a detailed view of a main toolbar (including a main menu) for the interface;

FIG. 8 is detailed view of a file menu popup;

FIG. 9 is a detailed view of an edit menu popup;

FIG. 10 is a detailed view of a view menu popup;

FIG. 11 is a detailed view of a format menu popup;

FIG. 12 is a detailed view of a head's up display menu popup;

FIG. 13 is a detailed view of an insert menu popup;

FIG. 14 is a representative view of a complex trade object model;

FIG. 15 is a detailed view of a favorites toolbar;

FIG. 16 is a detailed view of a favorites setup toolbar;

FIG. 17 is a detailed view of a properties dialog element of the interface;

FIG. 18 is an overview of an alternate preferred embodiment of an interface including a matrix control element for use with a Complex Trade Object;

FIG. 19 is a generalized illustration of a trailer;

FIG. 20 is a generalized illustration of a semi-dynamic step trailer; and

FIG. 21 is a generalized illustration of full dynamic step trailer.

### DESCRIPTION OF THE SPECIFIC EMBODIMENTS

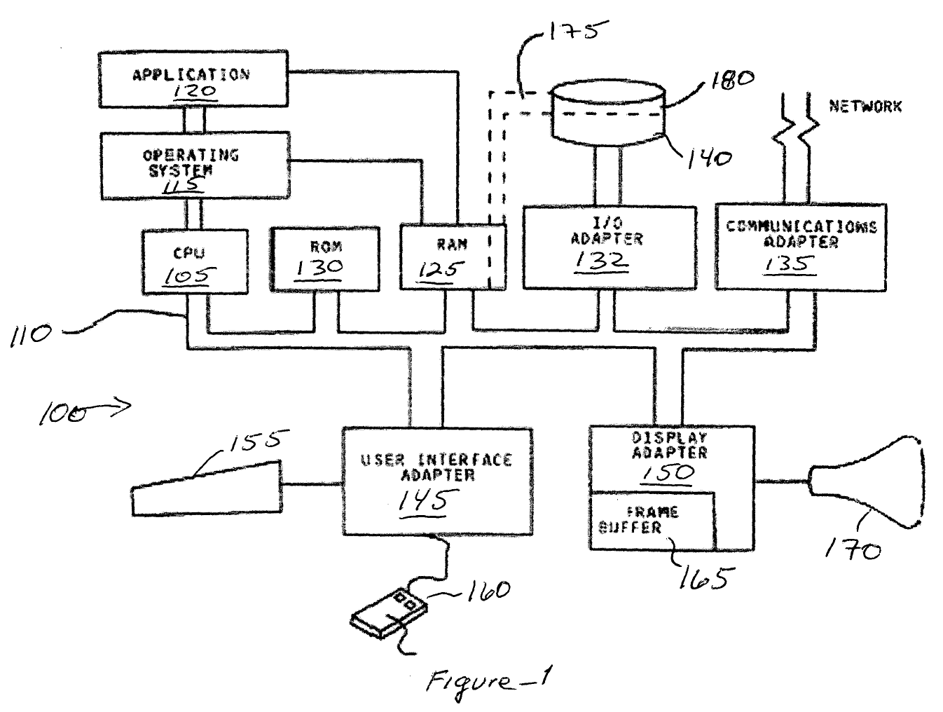

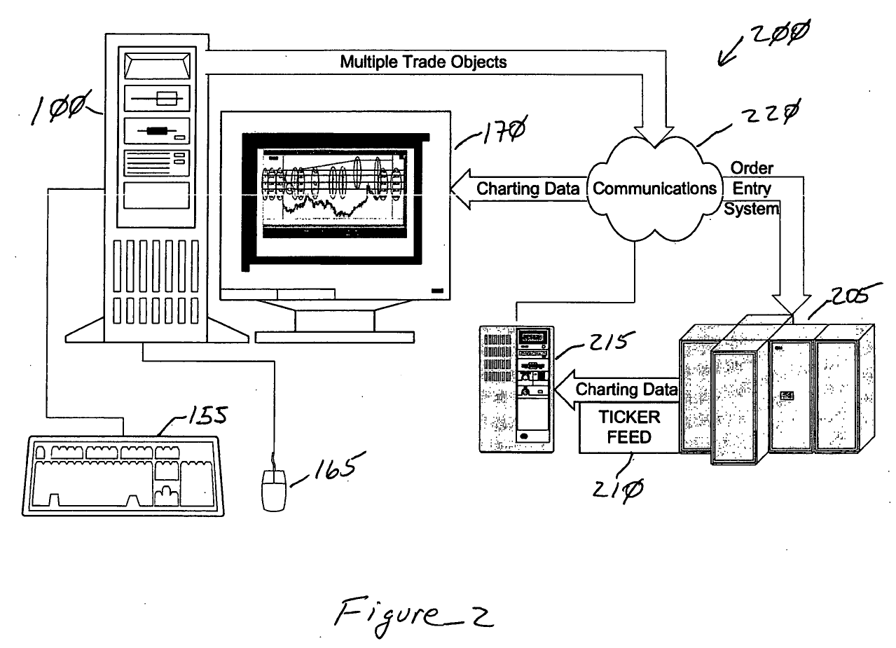

FIG. 1 is a computer system 100 that may function as a basic computer in implementing the present invention for enhancing a purchaser's ability to quickly translate a complex purchasing strategy and/or a desired purchasing discipline into an executable set of right transfer instructions (e.g., an order to buy something at a particular price). Computer system 100 includes a central processing unit (CPU) 105, such as one of the PC microprocessors or workstations, e.g. RISC System/6000 (RS/6000) (RISC System/6000 is a trademark of International Business Machines Corporation) series available from International Business Machines Corporation (IBM), is provided and interconnected to various other components by a system bus 110. An operating system 115 runs on CPU 105, provides control and is used to coordinate the function of the various components of FIG. 1. Operating system 115 may be one of the commercially available operating systems such as the AIX 6000 operating system or OS/2 operating system available from IBM (AIX 6000 and OS/2 are trademarks of IBM); Microsoft's Windows 98 or Windows NT, as well as UNIX and AIX operating systems. One or more application programs 120, controlled by the system, are moved into and out of a main memory RAM 125. These programs include the program of the present invention to be subsequently described in combination with data source(s) and order entry systems as shown in FIG. 2. A read only memory (ROM) 130 is connected to CPU 105 via bus 110 and includes the Basic Input/Output System (BIOS) that controls the basic computer functions. RAM 125, an I/O adapter 132 and a communications adapter 135 are also interconnected to system bus 110. I/O adapter 132 may be a Small Computer System Interface (SCSI) adapter that communicates with a disk storage device 140. Communications adapter 135 interconnects bus 110 with an outside network enabling the data processing system to communicate with other such systems over a Local Area Network (LAN) or Wide Area Network (WAN), which includes, for example, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160) are all interconnected to bus 110 through user interface adapter 145. It is through such input devices that the user may interactively relate to the programs for manipulating the interface control objects for manipulation of the complex trade object according to the present invention. Display adapter 150 includes a frame buffer 165, which is a storage device that holds a representation of each pixel on a display screen 170. Images may be stored in frame buffer 165 for display on monitor 170 through various components, such as a digital to analog converter (not shown) and the like. By using the aforementioned I/O devices, a user is capable of inputting information to the system through the keyboard 155 or mouse 160 and receiving output information from the system via display 170. The system also contains a memory cache 175 which is illustrated as a dashed line outline and includes a portion 180 of a disk storage drive 140 and a portion 185 of RAM 125.

FIG. 2 is a generalized diagram of a rights transfer system 200 using the computing system 100 including an embodiment of the present invention. To simplify a description and discussion of the present invention, a particular implementation for rights transfer system 200 will be described for trading stocks and related securities, though it is appreciated that the present invention may be implemented in other right transfer contexts. Right transfer system 200, for stock/security trading, includes computer system 100 configured for stock/security trading with a trading interface process as described later with regard to FIG. 3.

Additionally to computer system 100, rights transfer system 200 includes a mainframe or central computer 205 of a stock exchange providing data to ticker feed system 210 which constantly generates updated data on the prices and volumes of various stocks being traded. The updated data is delivered to a server 215 where the data is stored and accessible to systems connected to communications/distribution/network system 220. Information in server 210 is read by the trading interface process executed by computer system 100, such as the one illustrated in FIG. 1, which is designed to read and chart time-varying price-related data from server 210 regarding one or more shares with the pertinent data with respect to volumes, bid, offer, last, etc. The trading interface process presents the charted data on display 170.

The trading interface process responds to control signals from the I/O system of computer system 100 to set and adjust one or more trading controls overlaid on the charted data. The trading controls are responsive to data related to a price of an item graphically presented by the interface, and follow a user-defined protocol as described by the Trade Object when the time-varying price-related data reaches a predetermined relationship to the one or more trading controls. As used herein, price may refer not only to a price of an item as used in a conventional sense, but also to price derivatives and other price-related information. A price derivative includes, for example, a moving average or a measure of a change in the price versus time. In the following discussion, the term “price” therefore includes these concepts in addition to price in its conventional sense.

The multiple Trade Objects generated from computer system 100 are distributed through communications system 215 to an order entry system on computer 205. The distribution is typically done via an intermediary system operated by a brokerage company that checks, formats and issues specific trade instructions.

FIG. 3 is a representation of a representative graphical user interface 300 for a preferred embodiment of the present invention. As discussed above, the present description focuses on an implementation of interface 300 for a stock/security trading use, though the interface may be used in other contexts. Interface 300 is presented on display 170 and is responsive to trading control signals generated by the I/O system of computer system 100 and the information on server 210. Interface 300 includes three regions: an header bar region 305, an execution bar region 310, and a main interface region 315. Main interface region 315 graphically includes time-varying price data 320 and a set of interface tool controls 325 overlaid on, and responsive to, price data 320. Main interface region 315 is the main interface component and is the location where all Trade Objects are built and deployed. In the preferred embodiment, improving a user's speed in creating, editing and trading using complex trade objects is an important goal. The preferred embodiment applies focus to various control elements, and those elements respond to input/output system commands when they have focus. The control elements not only respond to mouse/cursor events, but may also respond to keyboard commands to cycle focus through valid elements. For example, <TAB> may cycle through the focus elements on an order line, and the user is able to position/adjust each the focused element as it obtains focus, thereby greatly improving responsiveness of the system.

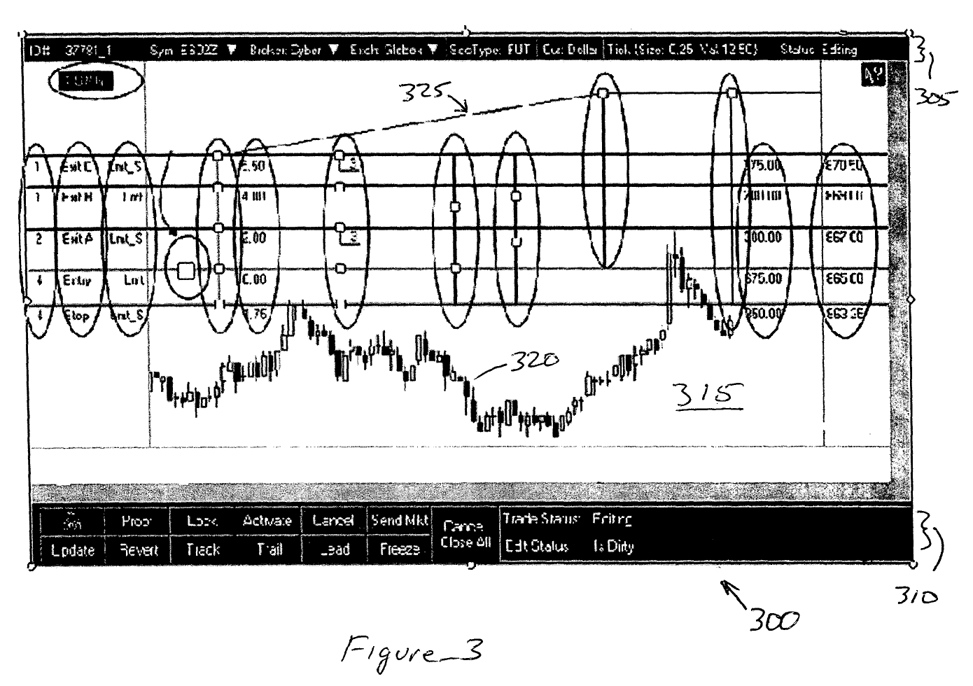

FIG. 4 is a detailed view of header bar 305. Header bar 305 displays important properties that are global to the Trade Object generated by interface 300. Individual Order lines of main interface region 315 may inherit one or more of these properties. Additionally, symbols, brokers and routes may be selected here as well. Other implementations may include other information or global properties in addition to, or in lieu of, those illustrated here. Header bar 305 includes an ID field 405, a symbol field 410, a broker field 415, an exchange field 420, a security type field 425, a currency field 430, a tick field 435 for size and value, and a status field 440. In the following discussion of the preferred embodiment, size is synonymous with quantity, and size/quantity refers to the actual amount of the “thing” or a representation of the actual amount (e.g., a number of contracts, with each contract representing a particular number.)

ID field 405 is a unique identifier for a trade ID number. The first 5 digits are the ‘Long’ data type value of the present date. The last digit or digits represents the trade number for the day. In this example the date is Jun. 9, 2003 and the trade is number 1 for the day. The unique identifier is constructed this way automatically. By logging trades with these unique identifiers, it is easy to run queries and generate reports by date. The user does not directly change this value.

Symbol field 410 includes a ticker identifier for one or more securities operated on by interface 300. By clicking the white drop down arrow, a list of “most recently” used symbols is displayed. The user may select from the list (e.g., “clicking”), or type directly into this cell to change/add a desired security or set of securities.

Broker field 415 displays a currently selected broker from a list of all available brokers presently ‘Plugged’ into interface 300. By clicking the white drop down arrow, a list of available brokers is displayed. The user may select a particular broker from the list (e.g., “clicking”), or type directly into this cell to change to a desired broker.

Exchange field 420 displays available exchanges or routes for the selected security given the selected broker. Clicking the white drop down exposes the list. The user may select a particular option from the list (e.g., “clicking”), or type directly into this cell.

Security type field 425 displays the security type. The security type is derived from the ticker symbol. Supported types include, for example, futures, stocks, options, bonds and currencies and are abbreviated respectively, FUT, STK, OPT, BND, and CUR.

Currency field 430 displays the present base currency. The default condition is U.S. Dollar. Virtually any other base currency may be supported, for example, Euro, Yen, Pound, Mark, Canadian Dollar, Peso, Ruble, Franc and Lire.

Tick field 435 includes the tick size and the tick value. The tick size is the fractional value relative to 1 base currency unit that the security ticks in. For example, stocks tick in a 0.01 to 1.00 ratio [a “1 cent” tick], but most other securities do not. Tick size first looks up the security in a list then applies the industry tick to tick size. The use is able to override this for certain securities in certain situations, as appropriate and qualified by interface 300. The tick value is the value per tick for leveraged securities. An example of a leveraged security is the ES contract [S&P 500 E-Mini] available from Global Exchange through various brokers. The tick value is $12.50, and the tick size is 0.25.

The status field 440 displays the messages relative a status of the global Trade Object operated on by interface 300.

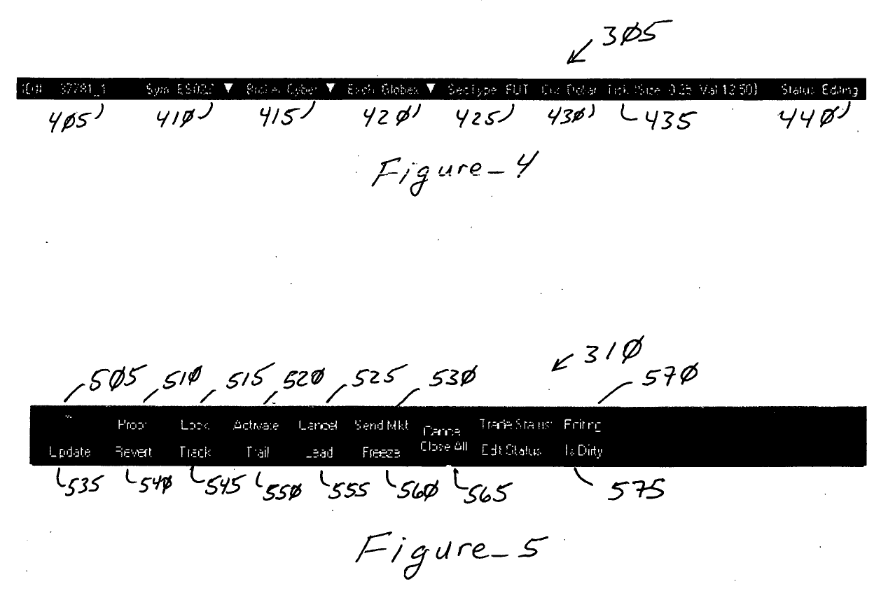

FIG. 5 is a detailed view of execution bar 310. Execution bar 310 initiates transmission of trades to market or sets up a trade as “ready and waiting” to be sent to the market. This is a main “execution” component of trading interface process 300. Execution bar 310 includes a camera control 505, a proof control 510, a lock control 515, an activate control 520, a cancel control 525, a sendmarket control 530, an update control 535, a revert control 540, a track control 545, a trail control 550, a lead control 555, a freeze control 560, an cancel-exit-close all control 565, a trade status indicator 570 and an edit status indicator 575.

Actuation of camera control 505 has several different functions, depending upon a user's choice. These functions include generation and storage of a screenshot, or generation of a journal entry with/without a screenshot. Camera control 505 serves to preserve a “snapshot” of all or a portion of interface 300 or the CTOM, or a portion thereof, as determined by context and user preference.

Actuation of proof control 510 sets in motion a proofing algorithm. All properties of the trade are checked out for valid data types and values. When an anomaly is discovered the user is alerted as to what the anomaly is and in some instances, how to correct or remove the anomaly, and in still other instances, an option is provided for correcting/removing the anomaly.

Successive actuations of lock control 515 alternately locks and unlocks the trade. A locked trade cannot be edited.

Actuation of activate control 520 activates the trade and sets its status as “Ready Waiting”. In this condition the trade is waiting for satisfaction of entry conditions before executing its protocol. Activated trades can be canceled.

Actuation of cancel control 525 cancels the “Ready Waiting” state of the trade and returns the trade to a status of “Editing” [locked or unlocked]. Once a trade goes “Status Live”, the user is unable to cancel the trade using cancel control 525.

Actuation of sendmarket control 530 takes the Trade Object and snaps it to the current market price and fires off an Entry Order as a market order. Once the Entry Order has been filled, the average entry price is calculated. The Trade Object will not adjust its entry price line, however a profit label parameter indicator will be adjusted.

Actuation of update control 535 sets any edit activity during a Live Trade to be included in the Live Trade. Until actuation of update control 535, the edit activity exists as a ghost companion to the standing Trade Object. Initiation of the update process triggers the proofing algorithm associated with proof control 510.

Actuation of revert control 540 is conceptually similar to an “undo” operation in an application. When a Live Trade has been edited and updated, actuating revert control 540 recalls the last condition and then updates the Trade to that last condition. Initiation of the revert process triggers the proofing algorithm.

Actuation of track control 545 locks the Trade Object's Entry Order to the current price and thereafter follows the current price. Only Trades with status “Editing” is able to use this feature.

Actuation of related trail control 550 and lead control 555 also locks the Trade Objects Entry Order to the current price similar to track control 545. Trail-Lead are responsive to trail offsets and lead offsets, respectively, that are lookup values set in advance by a user. Depending on a Action type of the interface [e.g., long, short] of the Trade Object, Trail and Lead behave differently. Trail is always being behind the price in terms of your Action and vice versa for Lead.

Actuation of freeze control 560 suspends further operations regarding the trade until freeze control 560 is actuated a second time. Unlike actuation of lock control 515, which only prevents further editing, freeze control 560 locks the Trade down. Interface 300 has greatly reduced functionality when a Trade is frozen. All controls are disabled accept freeze control 560 is available to un-freeze the Trade. Only available to Trades with a status of “Editing”.

Actuation of cancel-exit-close all control 565 immediately initiates a complete liquidation of the trade. Any and all server sided Orders are canceled. In some implementations, the liquidation may be profiled to attempt to track a particular liquidation strategy.

Trade status indicator 570 displays the global trade status. Various status indications of interface 300 include Global Trade Status states and Order Status states.

Global Status states include:
1. Editing
2. Activated
3. Canceled
4. Live
5. Closed

Order Status states include:
1. Disabled
2. Editing
3. Active
4. Next
5. 2nd Next
6. 3rd Next
7. (.) Next
8. Sent
9. Live
10. Cancel
11. Canceled
12. Filled.

The above listed Trade Status and Order Status states are resident to Interface 300. Other states are made available and are dependent on the particular brokerage interface that Interface 300 is adapted too. Each brokerage makes available their own unique set of Status states on the brokerage servers. The typical embodiment of interface 300 will include those additional states, and make them available to the user through interface 300.

Edit status indicator 575 displays the Edit Status of the Trade Object. Values include: “Is Clean” or “Is Dirty” indications. When you have made an edit change in edit mode, then the trade edit status indicates “Is Dirty.”

FIG. 6 is a detailed view of interface tool controls 325. Tool controls 325 includes the following elements: a size label 605, a name label 610, a type label 615, a main handle 620, a line handle 625, a tick label 630, a slip handle 635, a time element or elements 640, a trailer element 645, a profit label 650, a price label 655 and a flip label 660.

Size labels 605 illustrate Order size and are used by interface 300 to create and destroy Exits. Each size label 605 displays and sets the size of a specific Order line 665 that has focus, and under certain circumstances, may affect the size of other Order lines 665. A user is able to set focus for a particular size label, for example by clicking the particular size label. A particular size label 605 having focus is ready for user input. Size labels 605 respond to the I/O system, (e.g., a roll of the mouse wheel in the preferred embodiment is a sole method used to affect the values displayed and represented, though other implementation may use other or additional I/O systems). Valid values for any size label 605 include any whole number greater than or equal to zero or one, depending on the Order line. Size labels 605 are aware of each other and cooperate, due to shared properties they each represent. Changing a value of a particular size label may change values of one or more other size labels. A size label 605 may represent a stop size, an Entry size or an Exit size, though size labels bear a logical relationship to each other once one or more corresponding Order lines are established. In other words, making an Entry Order line 665₄ visible makes subsequent Order lines 665 either Exit lines or a stop line.

A stop size label 605 responds to wheel roll events and is associated with a stop Order line 665₅. Rolling up on a stop size label when the action is long increases the value, and when the action is short decreases the value. The behavior is inverted depending on the action. Rolling down has the opposite effect of rolling up. For the following discussion, it will be assumed that the trade is long. To interpret this information for a short trade, simply exchange up for down and vice versa.

Rolling a stop size label affects the global size of the trade; there is only one stop Order line 665₅. The aggregate of the size labels of all Entry Order lines and of all Exit Order lines each match the size of stop size label 605. Therefore, changes to the stop size label 605 may change the value of one or more other size labels 605. When an Order line 665 is visible [size greater than zero], than that Order line too will change in value. In the case of an Entry size label, it will match or always equal the stop size label value. When only one Exit size label 605 is visible, then that too will match the value of the stop size label 605. This is known as a square trade.

When a multitude of Exit size labels 605 are visible, they collectively will match the value of the stop size label. Changing the value of the stop size label will collectively effect all visible Exit size labels. A user may have multiple options in defining a relationship of the change of individual ones of the Exit size labels when the collective value changes. When rolling up and two Exits are visible then the first Exit size label (an Exit size label closest to the Entry size label) gets preference until it is greater then the second Exit size label. When the first Exit size level is equal to the second Exit size label +1, then the second Exit size label will get the value, automatically creating a condition known as square exits. Square exits refers to a condition whereby each of the Exits in a Trade Object have equal size or quantity.

When rolling down and two Exit size labels are visible, a reverse of the roll-up occurs. The Exit size labels alternate between being square, and having the first Exit size label equal to the second Exit size label +1. When the size of the second Exit size label is 1 and the mouse is rolled down, that second Exit size label (corresponding to the Order size of a second Exit) becomes zero, and the second Exit Order line 665 is visibly extinguished from the interface. The trade has become square.

When rolling the stop size label up or down and three Exit size labels are visible, the interface distributes the values roughly in a 3:2:1 ratio from the first size Exit label. The first Exit size label gets the greatest value, and the last Exit size label gets the least value. When the size of the third Exit size label is 1 and the mouse is rolled down, a third Exit Order size becomes zero, and third Exit Order line 665 is visibly extinguished from the interface. The trade will only have two Exits unless further modified.

Entry size label 605 behaves the same as stop label 605.

Exit A size label 605 (first Exit size label closest to Entry size label) is an interface tool for producing or creating additional Order lines 665. When Exit A size label 605 is equal to 1 and the current Trade Object is square [e.g., 1×1×1], rolling Exit A size label 605 up, sprays out additional Exit Order lines 665 each having an Exit size label until there are a total of three Exit Order lines each with a size equal to 1. Continued rolling up after three Exits simply increases a size of Exit A size label 605, as well as values for both stop size label 605 and Entry size label 605.

Rolling Exit A size label 605 down will decreases its value. When more than one Exit size label is visible, then the value for Exit A size label 605 initially rolls down to 1. Further roll-down of the value for Exit A size label 605 decrements the third Exit size label (When visible) until it is visibly extinguished, then further roll-down events decrement the value of second Exit size label 605 until it too is visibly extinguished.

Additional Exit “x” size labels 605 operate as described above. All of the Labels work in concert with one another, incrementing and decrementing their neighbors in a logical fashion. Modifying these values for the Exit size labels modify the value of the specific Exit size label 605, and the values of the Entry size label and the stop size label when they are visible. While the preferred embodiment uses a single Order line for an entry and a stop, and up to three Exits, other embodiments and implementations may use different numbers of Order lines and different relationships among the values, particularly when rights for a different type of priced-item are presented in the interface.

Name labels 610 display a name associated with each Order line 665. Values include stop, Entry, Exit A, Exit B and Exit C. Setting focus on one or more of name labels 610 using the I/O system (e.g., clicking) brings focus to the associated Order line(s) 665. The focused Order line 665 itself will then be responsive itself to the I/O system (e.g., by rolling the mouse wheel). Rolling up increases the value of the size label 605 associated with that Order line 665, and rolling down decreases the value.

When movement of an Order line makes it approach another Order line sufficiently close (either above it or below it), the approached Order line is also moved. The default value is to keep a two tick separation between the Order lines. The preferred embodiment does not permit Order lines to pass one another, so movement of an Order line may successively move additional adjacent lines as the group of Order lines approach sufficiently close (e.g., the two tick value).

Type labels 615 display the Order type for a particular associated Order line 665. Values for type labels include: market, limit, and limit slip. Focusing one or more type labels 615 makes it ready for user input. The values of type labels 615 of the preferred embodiment respond to the roll of the mouse wheel as the sole method to affect the values they display and represent. Continued rolling loops through the valid Order types that are available.

Main handle 620 is a grab handle that permits a user to move an entire Trade Object as a unit; up-down and left-right. The Trade Object is the collection of the visible Order lines and their relative position. Moving the Trade Object may change the values of the size labels and other parameters. Main handle 620 is responsive to the I/O system and may be focused and rolled and/or dragged to set desired values with mouse-down and mouse-move events.

Line handles 625 are also grab handles that allow another method of focusing an Order line 665. As discussed above, an Order line having focus is responsive to the I/O system and may be modified by roll-up and roll-down events, among other types of controls Tick labels 630 display the value in points [value set in header bar 605 with default being US Dollar] that its associated Order line is ‘away from’ the Entry Order line 6654. Entry Order line always displays 0.00 points as it is the basis of zero in the Trade Object of the preferred embodiment. Other embodiments and implementations may use a different “zero” reference, then the Entry Order may have a non-zero value. Focusing on one or more tick labels 630 allows user input from the I/O system. Tick labels 630 may be dragged left and right to facilitate better readability.

Slip handles 635 are grab handles that accept focus for user input. Rolling these handles increases or decreases the ‘Slip’. Slips may be globally disabled. Slips affect available Order types. When slips are off, then the Order type limit slip is unavailable. By making slips visible, it is implicit the user wants them to be available.

Slips are auxiliary price levels associated with the limit order they are attached to. By setting a Slip to a quantity of Ticks or quantity of price increments a range is defined where by the limit order will act as a market order within the prescribed range.

Slips are a method that increase the likely hood of exiting or entering the trade (or getting an intermediate order filled) once the Order price level is hit by the market conditions.

By increasing the number of ticks in the slip setting to or beyond a user defined value, the Limit order will be treated as a market order. In this method, the Order line becomes a standing market order waiting to execute, and will take any price the market offers to effect either the entry or the exit.

Slips give the user additional flexibility in crafting Trade Objects. Like all elements of Interface 300, the Slip tools are embedded in the chart interface and the slip values can be created, edited and managed in a context sensitive method.

Time elements 640 are grab handles that accept focus for user input. Rolling these handles repositions the handle vertically. These grab handles may also be dragged vertically and horizontally. Time is the second axis of any price-time matrix, which in interface 300 is the horizontal axis. Price is the vertical axis, therefore vertical values of the time elements are provided no meaning in the preferred embodiment. The time elements 640 include an entry time tool and an exit time tool. The entry time tool is only available or valid prior to execution of an initial Entry Order. The exit time tool may be used following execution of the initial Entry Order. Any time value for time elements 640 [Exit or Entry] less than (i.e., ‘older’ than) the present time is invalid. Exit time values are not permitted to be less than (i.e., ‘older than) entry time values. Time elements 640 may be globally disabled/enabled. By enabling the time elements 640 (e.g., making them visible), it is not implicit that user desires to use them. Disabling time elements 640 globally or individually (e.g., making them invisible) implicitly prevents their/its use. Time elements 640 of the preferred embodiment have both an “activated” and a visible property set positive in Order to be used. Right clicking a Time element exposes a menu that allows them to be individually employed.

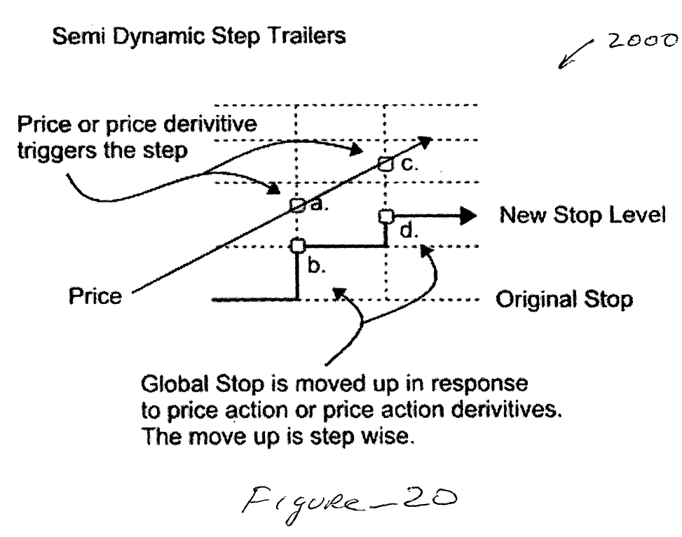

Trailer elements 645 are grab handles that accept focus for user input regarding trailers. Trailers are objects containing properties that when compared to market price action, price action derivative, instruct the interface to adjust the Global Stop line, with FIG. 19 illustrating the general concept of a trailer.

Understanding Global Stops and Exits:

Global Stops exist to limit loss. They are defined as price points or trigger lines where the interface initiates liquidation of all or a portion of a Trade as defined by the user. Stops are the opposite of Exits (profit taking points).

Exits exists to preserve profit. They are defined as price points or trigger lines where the interface initiates liquidation of all or a portion of the Trade as directed by the user.

Defined in this context and as conventionally understood, Stops and Exits are static price lines; static to the extent that the user manually adjusts their levels to effect a change in their value (price).

Trailers:

Trailers are objects that manage the Stop level in relation to price action or price action derivatives, as well as events generated by interface 300. Trailers exist to further limit loss and or preserve profit. Trailers are comprised of a trigger or action value, and a result or product value. The syntax for a trailer object is:

If condition [trigger or action value is true] then either move Global stop line to value OR make Global stop line dynamic and trail price or price derivative as defined by the value or range between the trigger handles and the value handles.

Types of Trailers:

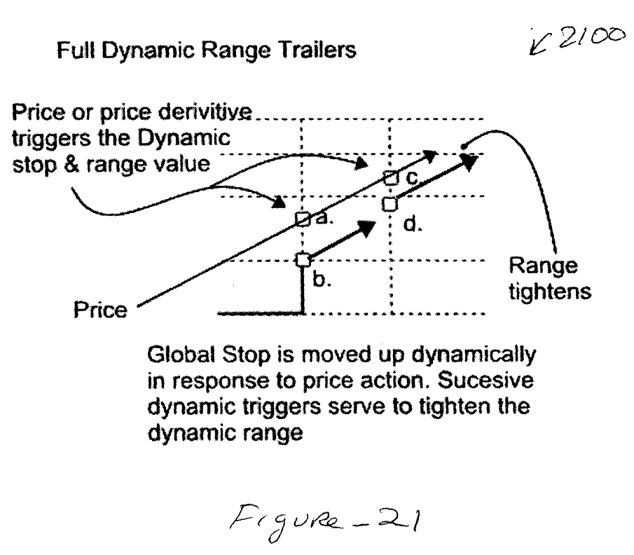

1. Semi-Dynamic Step Trailers illustrated in FIG. 20: If condition (a) true then move global stop to action point (b): (Stop=Stop+Abs((a−b)). If condition (c) true then move global stop to action point (d): (Stop=Stop+(Abs(c−d)) . . . value . . . value.

The semi-dynamic stop steps up the global stop in increments as defined by the trigger point, and action point. In the preferred embodiment (assuming the trade is long (not short)), the action would be as follows. When the market price action hits the trigger handle price value (a), the trailer object moves the lower initial global stop line to (b). When the price action next hits (c), the trailer object moves the global stop line to (d) In a stepwise fashion, the global stop is moved up in the Semi-Dynamic Trailer.

2. Full Dynamic Range Trailers illustrated in FIG. 21: If condition (a) true then make global stop trail market price by the range defined between the trigger (a) and the action point (b): (Abs(a−b)). If condition (c) true then make global stop trail market price by the range defined between the trigger (c) and the action point (d): (Abs(c−d)).

The full dynamic stop trails the market price by the range defined between the trigger and the action price levels. If more than one dynamic stop is deployed, the second dynamic stop trigger point would serve to further contract the range of the trailing global stop. In a typical embodiment of the method, and in reference to the above figure (assume the trade is long (not short)), the action would be as follows. If the market price action would hit the trigger handle price value (a.) the trailer object would latch the global stop to the present market price, and track behind the market price as defined in the range Abs(a−b). As the market price rises the global stop is updated and moved further up, maintaining the Abs(a−b) range behind the market price. If the market direction changes the global stop would not retrace. Deploying more than one dynamic stop is a method to tighten or decrease the trailing range. By deploying a second full dynamic stop with a tighter trailing range, allows the user to adjust the range incrementally.

3. Other Considerations:

Both Semi Dynamic and Full Dynamic Trailers can be deployed together concurrently, or as a type exclusively. The user has full flexibility in choice. Like all elements of interface 300, the Trailers are creatable, editable and manageable from the chart interface.

The dynamic Stop range tightening is not limited to a stepwise incremental reduction of the range as described by the range between the trailer objects. A dynamic stop can reduce its range automatically based on a ratio of a forward projected range. In this method, the forward price point defines a range between that forward price point and the trigger price point. The forward range is compared to the dynamic stop range, and as the price moves up, toward the projected point, the relative reduction in the forward range as expressed in a ratio can be applied to the dynamic stop range. In effect this method automatically tightens the dynamic range as the price moves to the target point. In this method, those forward points can be arbitrary user chosen values, or the any of the pre-defined exit points when compared to the actual price or a price derivative.

Rolling trailer elements 645 increases or decreases the value of the associated trailer. Trailers may be globally enabled/disabled. Rendering trailer elements visible makes it implicit that the user wants to use them. Right clicking a particular trailer element 645 exposes a menu that allows the user to make fully dynamic.

Profit Labels 650 display the profit for each individual Order line 665. Profit label 650 associated with the Entry Order line 665 displays the aggregate profit of all visible Exit Order lines 665. Profit labels 650 accept I/O system events for providing focus to the associated Order line 665. Profit labels 650 may be dragged left and right for positioning, as desired by the user.

Price labels 655 display the real world price of the associated Order line 665. Price labels 655 accept I/O system events for providing focus to the associated Order line 665. Price labels 655 may be right button mouse-downed and/or wheel rolled to adjust associated slips when slips are visible.

Flip label 660 flips the entire trade over when it is actuated through the I/O system, and flip label provides a visual indication of whether the trade is long or short. When the trade is long, both the trade and the indication becomes short in response to actuation of flip label 660. Similarly, when the trade is short, they becomes long responsive to use of flip label 660. Flipping a trade “rotates” a trade about a rotational axis that in the preferred embodiment is the Entry Order line [zero].

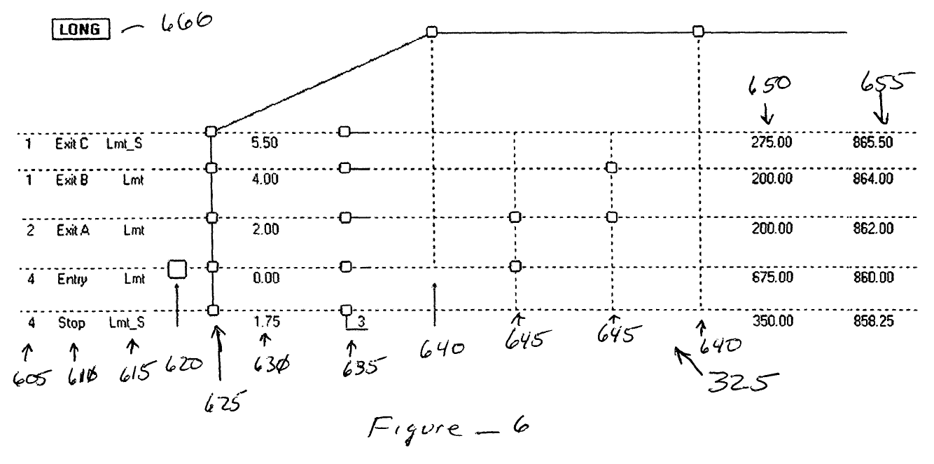

FIG. 7 is a detailed view of a main toolbar 700 (including a main menu 705) for interface 300. Additionally, the user may selectively enable display of a heads_up_trading toolbar 710, a standard journal toolbar 715, a format toolbar 720 and/or a favorites toolbar (shown in FIG. 15). Different embodiments may include different options, functions and toolbars or may aggregate the options, functions or toolbars differently without departing from the present invention. Main toolbar 700 is a preferred implementation for security trading using interface 300 having a journal.

Toolbar 710 includes controls for opening and saving trade objects, and for setting up a new trade object. Additionally, a control element is provided for toggling a visibility of the entire trade object and its tools. Included are two buttons for trade creation features: a retracement button provides for dragging out Trade sets based on a Fibonacci style retracement tool; and a rectangle button provides for simply drawing a rectangle across the chart using the I/O system (e.g., mouse) and by virtue of the rectangle's size and parameters associated with the drawing and orientation on the chart, a trade object is created on the chart. For example, depending on the direction of the drag vertically, the Rectangle Trade will know whether the trader is setting up the trade object as Short or Long.

Toolbar 710 includes a trailing elements control. Actuating this button toggles the visibility of the Trailing elements interface control elements. There is an associated drop down menu that exposes all of the tools associated with the Trailing elements control. A user is able to right-click a trailing element to select a popup menu including trailing elements control properties, including visibility.

Toolbar 710 includes a slips element control. Clicking this control toggles the visibility of the Slip elements of interface 300. A user is able to popup a right-click menu on slip elements to also toggle the visibility. Slips are sometimes also known as “Auxiliary” tick levels. In essence the slip elements turn the trade line into a trigger line. The “Slip”, or tick count is what a user is willing to give up in terms of “Ticks”.

Toolbar 710 includes a flip trade control. Clicking this button flips an entire trade object from long to short or vice-versa. When the trade is not “Live”, the whole trade will flip over about the Entry axis. Flipping an active or “live” trade requires customization as to user preferences regarding trading strategies and needs.

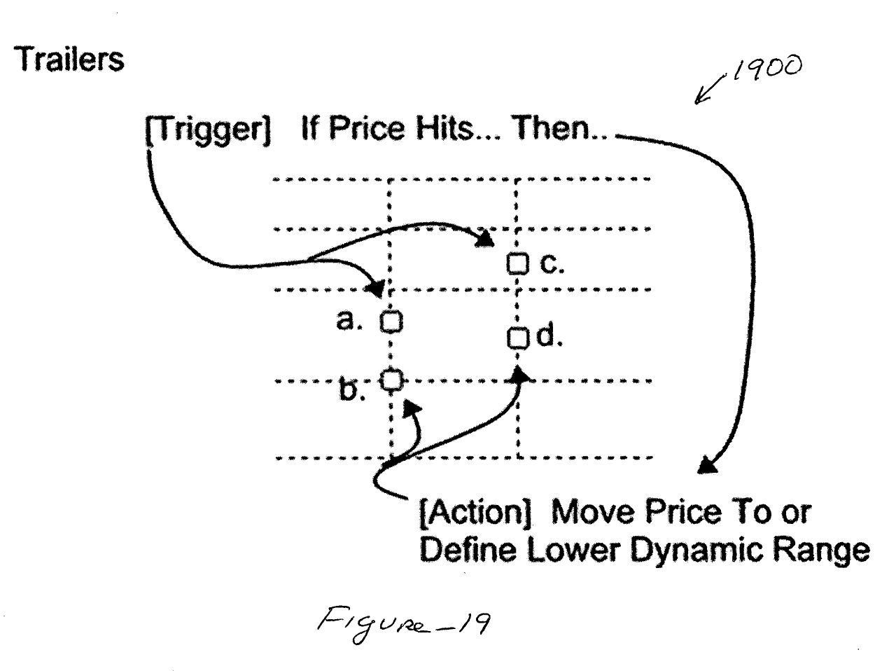

Interface 300 includes several optional viewing panes for presentation of trade-relevant information to a user. Toolbar 710 includes controls for toggling these panes, including a left pane, a lower pane and a top pane. The lower pane includes views for the journal and an events viewer. Events viewer is a textual display of time-stamped activities for the trade object, the chart data or interface 300 and is toggled using a control of toolbar 710. The journal is toggled using a journal viewer control of toolbar 710 and includes time-stamped user-notes, events and trade object data added by the user. Toolbar 710 also controls a journal input pad for permitting addition of notes without toggling the journal. Additional interface and object properties are set using a properties dialog (shown in FIG. 17) and a line formatting control available from toolbar 710. Line formatting controls the presentation of the various lines of the interface control elements (e.g., color, weight, and style).

Toolbar 715 provides elements for the journal. Controls include new, save, open, print, preview, page setup, clipboard controls, searching, and insert controls (e.g., time, date, or picture) for working with the journal viewer.

Toolbar 720 provides elements for format control of the journal text. Font, font size, alignment, and other types of controls are provided.

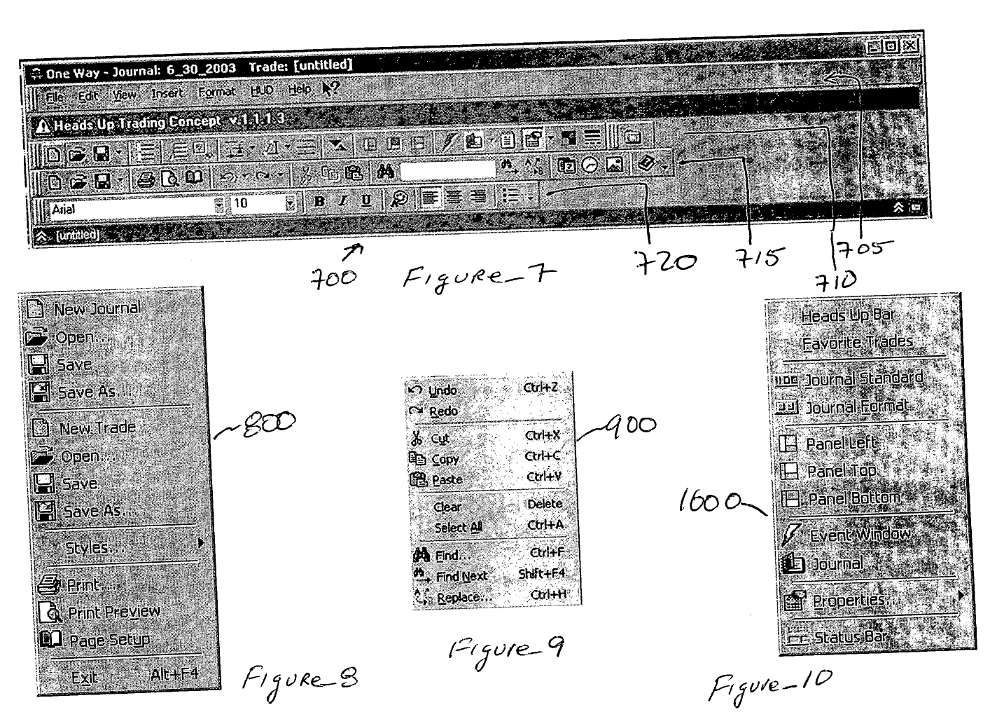

FIG. 8 through FIG. 13 are detailed views of individual menu popups resulting from selection of an option of main menu 705.

FIG. 8 is detailed view of a file menu popup 800. File menu 800 includes options for: Open a new document, Open an existing document, Save the open document, Save the open document “As” another name, Open the default trade, Open an existing trade, Save the open trade, Save the open trade “As” another name, Open the Styles pop menu., Print the Journal, Preview the Journal, Set up Journal page preferences, and Exit the program.

FIG. 9 is a detailed view of an edit menu popup 900. Edit menu 900, available for the journal viewer, includes options for: Undo last, Redo last undo, Cut the selected text, Copy selected text, Paste, Clear selection, Select all in document, Find, Find Next, and Replace.

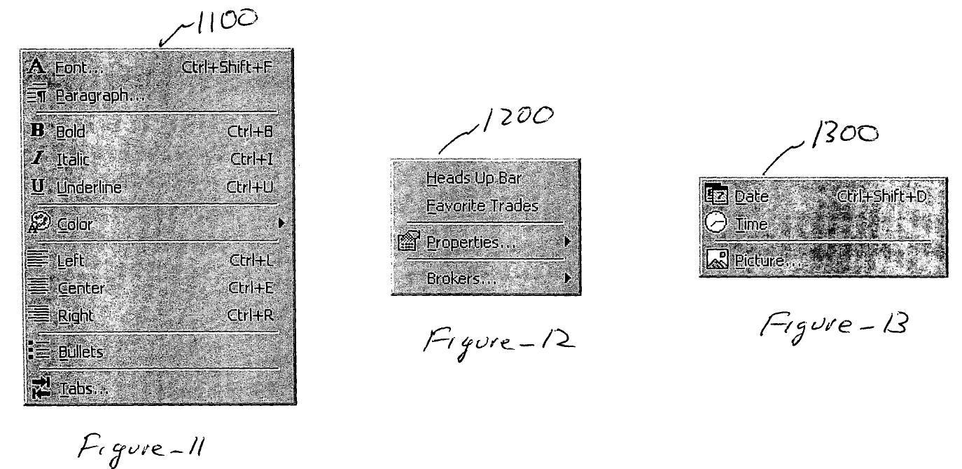

FIG. 10 is a detailed view of a view menu popup 1000. View menu 1000 includes options for: Heads Up bar, Favorites bar, Standard bar, Format bar, Left panel, Top panel, Bottom panel, Event viewer, Journal viewer, Properties dialog., and Status bar [Journal].

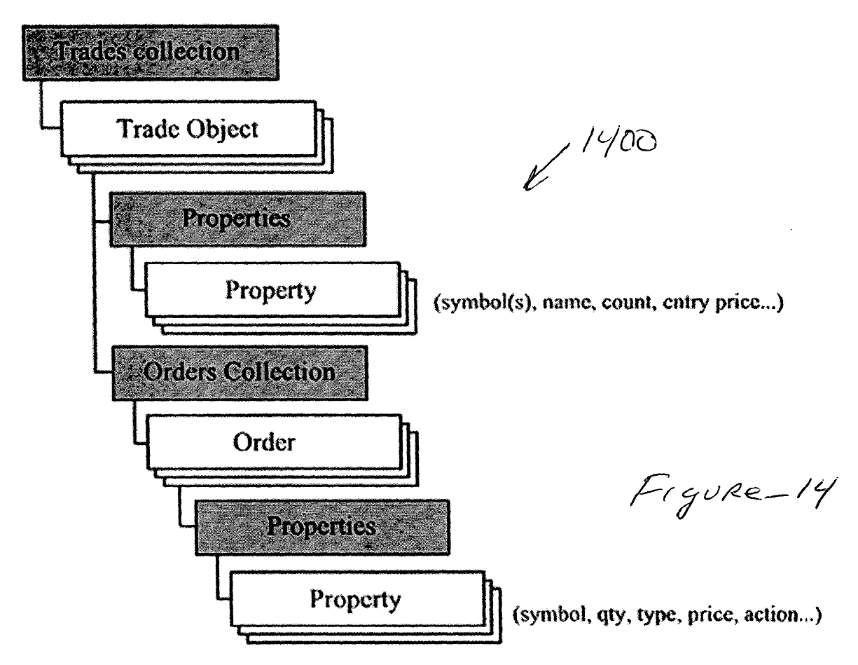

FIG. 11 is a detailed view of a format menu popup 1100. Format menu 1100 includes options for: Opens font dialog box, Opens paragraph dialog box, Makes bold selected text and caret, Makes italic selected text & caret, Makes underline selected text & caret, Opens font color dialog, Justify text left, Justify text center, Justify text right, Add bullet or bullets, and Opens tab dialog.

FIG. 12 is a detailed view of a head's up display menu popup 1200. Display menu 1200 includes options for: Show Heads Up bar, Show Favorite bar, Show Properties dialog, and Popup Brokers Menu.

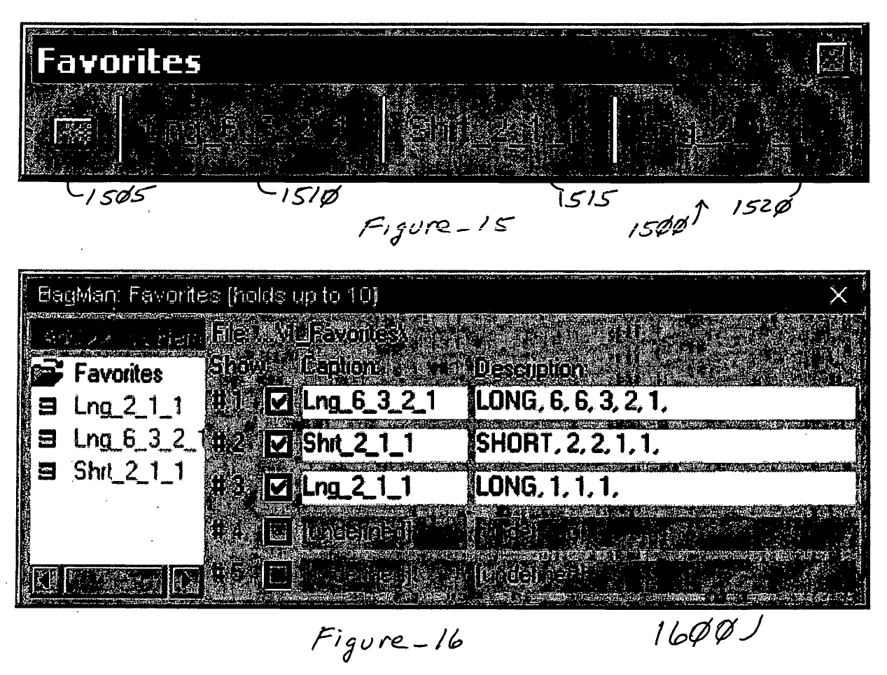

FIG. 13 is a detailed view of an insert menu popup 1300. Insert menu 1300 includes options for: Insert Date Stamp, Insert Time Stamp, and File Open for files of type: .bmp, .gif, .jpg (for example).

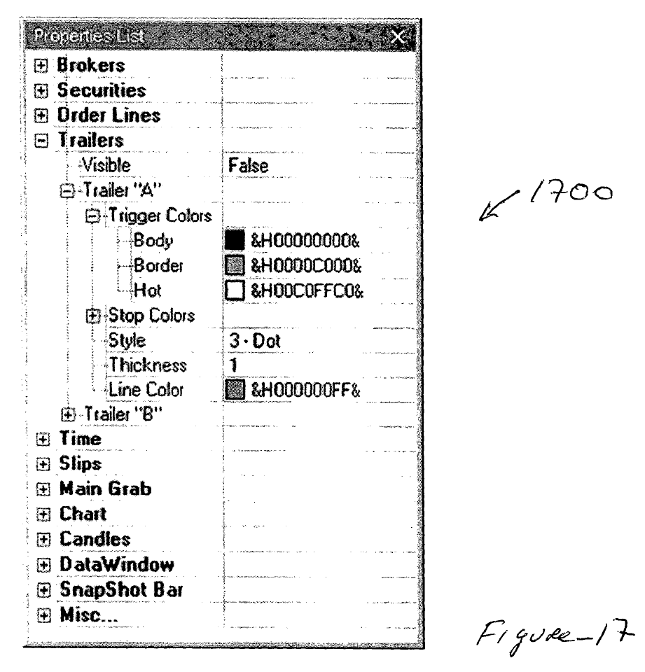

FIG. 14 is a representative view of a complex trade object model 1400.

Model 1400 dispenses with the idea or notion that a Trade consists of a single purchase or sale of a “thing” (e.g. a security). Rather, model 1400 provides that the Trade is considered a complex object including an Orders Collection or group of ‘Orders’; Trade=(Order A, Order B, Order C . . . )

Each ‘Order’ within the Orders Collection possesses a collection of ‘Properties’, that is Order=(Property1, Property2, Property3 . . . ) The ‘Trade’ itself also possesses its collection of Properties. The Trade Properties are global to the Orders; that is to say that the Orders inherit the properties of the Parent Trade Object.

Consequent to the concept of the Complex Trade Object Model is the provision that many ‘Orders’ or parts of the Trade are never acted on or ‘Executed’. Consider the example of a simple Three Order Trade; it has an Entry, a Stop and an Exit. Only two of these three Orders will ever execute.

Further, included in the Complex Trade Object are multi branch decision structures, such as multiple ‘Entry Orders’ and ‘Exit Orders’. A Trade Object is able to pare in and pare out of the Market; building and decreasing the position size as defined by the Trader. Model 1400 is not limited to a single “thing” as the concept is extended further to build Trade Objects that include more than one ‘Security’. There are many possibilities, where an element of the object (including trade, trade properties, order, and/or order properties) is conditioned on one or more events or other object elements.

Complex object model 1400 frees up the Trader from the single line approach to Trade or rather ‘Order’ creation. It puts in the hands of traders a powerful concept and tool. Interface 300 presents, builds, edits, saves, recalls, restores, and executes based upon model 1400.

Interface 300 and interface 1800 of the preferred embodiment operate in close association with the Complex Trade Object Model (CTOM) shown in FIG. 14. CTOM provides that a Trade is made up of individual Orders. CTOM is one solution for allowing multiple entry and exit points in a trade. Without Interface 300 or Interface 1800, the creation, editing, saving and deploying of complex trading strategies and Objects as embodied by CTOM is very difficult if practically possible.

CTOM (in cooperation with Interface 300), allows for many benefits to the user not practically possible otherwise.
1. CTOM properties are kept in the virtual CTOM Object Class.
2. All of these properties, or a selected subset, are writeable to memory (e.g., harddisk) to facilitate storing ‘Favorite’ Trade Objects.
3. Serializing the CTOM Object Class properties into a collection, and then iterating and enumerating over that collection, permits a many desired sets of the CTOM properties (different favorites) to be saved into a relatively small (e.g., 2 kb though size will vary with storage protocol and amount and type of storage) binary file (e.g., a “*.dat” file).
4. Reading the favorite (the saved binary file) into the CTOM object recreates the CTOM with the saved properties of the particular favorite without having to build the CTOM from scratch. The rebuilt CTOM may be further edited or executed. This greatly speeds the rate by which a user is able to deliver many trade instructions/orders at virtually the same time, and those trade instructions have the desired relationship to one another.
5. Interface 300 has a feature enabling the user to associate one or more favorites with one or more controls (e.g., buttons, menu items, graphics and/or interface element). Activating the control(s) reads the associated CTOM properties into the current CTOM trade from memory virtually instantaneously. Once the favorite is developed and written into memory, no more than two mouse clicks are needed to apply an entire complex trading strategy appropriate for a particular market condition (as represented by the favorite) may be implemented with interface 300. A first click reads the favorite properties and a second click executes the object. In cases where the favorite is close, a couple of more clicks and button rolls adjusts the CTOM trade to the particular circumstances prior to execution.

Interface 300 provides the user with a Trade Journal. CTOM serialization is further expanded into a Trade Journal interface that records a user's notes and desired information throughout a trading session. The CTOM data may be saved before, during and after a Trade. In a preferred embodiment of this concept, the CTOM data would be represented by a graphic Icon or button embedded in the typical word processor type display of a Journal. By clicking the Icon, the data in the stored CTOM object is read and then written into the Journal.

All of the data is expanded and viewable to the user for that particular snap shot. By clicking on the Icon again that data is removed from the Journal text, and is in essence collapsed from view. The data remains in memory in the binary file, ready for viewing again whenever the user desires. The user may elect to save additional binary data comprised of Chart settings and market conditions and data. In this way the Journal interface, in addition to displaying the data in a textual format, is able to repopulate the Chart display interface with CTOM object and the historical market data for that slice or snapshot of time, permitting a close inspection, review and analysis of the trade, events leading up to execution and events following execution of various components of the trade.

The user is able to browse through Journal files, with the user clicking on embedded CTOM Icons to populate the journal's text interface with data associated with that CTOM Icon, as well as repopulate the chart with both the historic data, and the CTOM object. This allows the user to study and review past performance in both a text and graphic presentation.

CTOM Objects are maintained in a master collection of objects. Interface 300 searches CTOM objects by valid property description and value, or a combination of valid descriptions and values to produce reports, and search histories by result. This ability allows the user to view the Trade Journal in ways other than the chronological entry order of those Journal entries. For instance a user is able to run a search for long trades on Stock ‘A’, for the month of June, that were profitable. CTOM allows this type of flexibility and power.

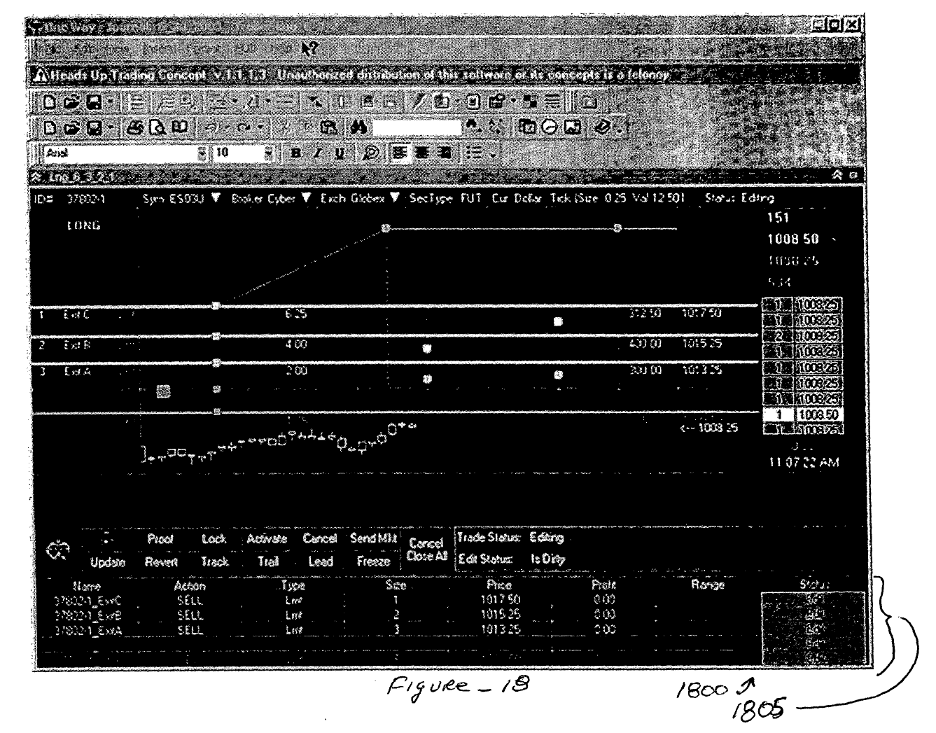

FIG. 15 is a detailed view of a favorites toolbar 1500. Toolbar 1500 includes controls for launching a favorites dialog (FIG. 16), and for loading favorites stored using the favorites dialog. Up to ten favorite trade objects are available on toolbar 1500, with the favorites dialog controlling which ten are available at any given time. Toolbar 1500 includes three favorites (1510, 1515, and 1520) to simplify discussion. The default is to label the favorite with the type of trade (long or short) and the size of the entry and the exits. Thus, favorite 1510 builds a trade object for a long trade with an entry of six and exits at three, two and one. Further, the particular tick relationship and other desired properties of the trade object that existed when the object was saved as a favorite are preserved as well. Favorite 1515 is a short trade having an entry of two and two exits, while favorite 1520 is a long trade having an entry of two and two exits.

Since an entire complex trade object is recalled using a single input command from the I/O system (preferably the mouse), a user may execute many complex trading strategies with a series of mouse clicks. A user may successively click a favorite, click execute, click another favorite and execute it, etc., thereby quickly define a multitude of positions in a matter of seconds. All properties of the trade object are adjustable using interface 300 through mouse events (dragging, scrolling, rolling, etc.) so a users need not ever have to type in variables or parameters. A user monitors the charting data with all information regarding the trade object, and adjustments to the size, value and number of exits, and the stop are monitored and adjusted just as easily as they were established. The user does not need to move between a keyboard or other entry system and the mouse, and the user does not need to move from the chart to the execution system.

FIG. 16 is a detailed view of a favorites dialog 1600. Favorites dialog 1600 maps saved trade objects to one of the available favorites buttons on the favorites toolbar 1500 (ten are supported in the preferred embodiment though other embodiments may support a different number). Any trade object on the interface is first “saved as” a favorite, then those choices are available in dialog 1600. A trader highlights a desired saved favorite in the treeview pane and triggers the “add” control, thereby assigning the highlighted favorite to the next available favorite position. The user may change the caption and/or the description, and check/uncheck the associated “show” button. Checked favorites are presented on toolbar 1500 with the caption. The description is for use within the dialog.

FIG. 17 is a detailed view of a properties dialog element 1700 of the interface. Properties dialog 1700 provides a simple tree-oriented list of user-modifiable parameters for interface 300. Dialog 1700 of the preferred embodiment does not include trade object properties, thus dialog 1700 may not be used in this embodiment to change trade-specific values.

FIG. 18 is an overview of an alternate preferred embodiment of an interface 1800 including a matrix element 1805 for use with a Complex Trade Object. Interface 1800 is similar to interface 300 described above with the inclusion of optional matrix element 1805. Some traders may be more comfortable with setting/reviewing/monitoring selected trade object properties in a more traditional “spreadsheet” model. Matrix element 1805 provides an additional property display/modify option rather than relying exclusively on the more preferred interface 300.

In both cases, the interface operates in cooperation with the complex trade object. Interface 300 provides many benefits to a user, including:
Trades and Charting in One Display
For the first time the user is able to watch a single display to see critical trade information and charting price action on his favorite charts. Heads-Up Trading.
Single Button Trade Creation
The user is able to populate the chart with a trade by pressing a single button. The object will be read from file depending on the button selected. Favorites will be available from file as well as a user defined default trade set. All buttons are programmable by the user.
Drag and Drop Trade Creation
The user with the swipe of his mouse is able to drop a trade on his chart defined by the limits of the rectangle drawn. Depending on which trade drawing tool he chooses, all the parameters will be drawn from a default template for that particular tool. All draw tool defaults are programmable by the user.
Context Sensitive Trade Editing
ALL aspects of the trade can be manipulated with a mouse drag event. The user is able to drag individual elements or the entire trade to position it to the chart. The object snaps to the grid of the chart based on the user's preference of tick value. ALL aspects of the trade can be manipulated by high lighting an element and rolling the mouse wheel to change its values.
Create Complex Trade Objects
The user is able to create Complex Trade Objects with multiple entries, stops and exits. The user is able to invoke trailing stops or conditional stops. The user is able to set up reversal trades; in essence multiple trades.
Save & Load Trades to File
The user is able to save and manage a data base of trades.
Quick Access to Favorites
Quick trade recall via favorites using draw or button interface.
Flip an entire trade.
Flip the entire Trade at the touch of a button either before or during an active Trade. Flipping while a Trade is active in essence reverses the entire Trade.
Make Trade Waiting on Price Action
The user is able to set the Trade ready/waiting, and when the price action meets the initial entry price, the Entry Order is executed and the Trade follows its predefined management protocol.
Snap to Market and Execute
The user is able to snap a Trade to the market price and execute the Trade. In this scenario the Trade bypasses the conditional entry triggers and immediately goes live, following its management protocol.
Trigger Trades on External Events
The user is able to set the Trade to respond to an external conditional event, such as a technical indicator or price-time derivative. In this scenario the Trade Object snaps to the market, the Entry Trade is executed and the Trade follows its predefined management protocol.
Cancel and Close All
Withdraw a ready/waiting Trade or close and cancel all elements of an active Trade with the touch of a button.
Set Time In and Time Out for Trades
Set a time in parameter for a Trade. When the price trigger does not occur before the time limit, the Trade is withdrawn as ready/waiting. Set a time out parameter for a Trade. When the Trade is active and the price action has not triggered the exit scheme, exit the Trade immediately and cancel all pending Orders.
Log Results to a Journal
The user is able to enable logging to a trade journal.
Save Trade parameters and data.
Save Trade results.
Search journal by Trade parameters and data.
Search journal by results. Make notes to the journal in real time.
View journal off line.

One of the preferred implementations of the present invention is as a routine in an operating system made up of programming steps or instructions resident in RAM 125, FIG. 1, during computer operations. Until required by computer system 100, the program instructions may be stored in another readable medium, e.g. in disk drive 140, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

The above-described arrangements of apparatus and methods are merely illustrative of applications of the principles of this invention and many other embodiments and modifications may be made without departing from the spirit and scope of the invention as defined in the claims.

These and other novel aspects of the present invention will be apparent to those of ordinary skill in the art upon review of the drawings and the remaining portions of the specification.

1. A computer-implemented method for generating a right transfer instruction regarding a transferable right in a priced item, comprising the steps of:
presenting graphically a chart of a price of the priced item versus time; and
setting a trigger control overlaid on said chart that is responsive to said price to initiate the right transfer instruction when said price reaches a predetermined relationship to a particular price for the priced item.

2. A computer-implemented method for trading securitized properties, comprising the steps of:
forming an orders collection of a plurality of orders for a securitized property, each order having one or more order properties, wherein said orders collection includes one or more collection properties inherited by each order of said orders collection, said properties applied by a computer system; and
executing one or more orders of said orders collection wherein an execution of a subsequent order after execution of one or more previous orders of said orders collection are dependent upon said properties.

3. A computer-implemented method for generating a right transfer instruction regarding a transferable right in a priced item presented by said computer, said computer having a computer program application that displays a graphical representation of price history of the priced item, the computer including computer code including I/O access commands, the method comprising:
presenting graphically a chart of a price of the priced item versus time; and
setting a trigger control, using the I/O access commands, overlaid on said chart that is responsive to said price to initiate the right transfer instruction when said price reaches a predetermined relationship to a particular price for the priced item.

4. An apparatus, comprising:
a communications system for receiving and processing a series of price-indicators for one or more priced items; a presentation system for displaying the series of price-indicators in a graphic format; and
a controller, coupled to the communications system, for overlaying one or more interface controls on the series of price-indicators, the controller responsive to user input instructions directed to the one or more overlaying controls for setting a parameter of the one or more controls and for initiating a right transfer process when one or more of price-indicators has a predetermined relationship to the parameter of the one or more controls.

5. An article of manufacture, comprising a program storage medium readable by a computer and embodying one or more instructions executable by the computer for generating a right transfer instruction regarding a transferable right in a priced item presented by the computer, the computer having a computer program application that displays a graphical representation of price history of the priced item, the program storage medium including computer code having I/O access commands, wherein: computer program code presents graphically a chart of a price of the priced item versus time; and sets a trigger control, using the I/O access commands, overlaid on said chart that is responsive to said price to initiate the right transfer instruction when said price reaches a predetermined relationship to a particular price for the priced item.

6. A trade object building method, the trade object having one or more properties defining one or more desired right interests in one or more priced rights in a thing, comprising the steps of:
presenting graphically on a chart a series of time-varying price-related information regarding the thing;
overlaying one or more interface control elements on said chart, said interface control elements responsive to one or more input/output control signals from a computing system coupled to the chart, wherein the interface control elements are associated with one or more specific properties of the one or more properties; and
modifying said one or more specific properties by operating on said one or more interface control elements.

7. The method of claim 6 wherein said specific properties include properties from the set of properties consisting of entry quantity, entry price, and exit price.

8. The method of claim 6 wherein said specific properties include properties from the set of properties consisting of entry quantity, entry price, exit price, and stop price.

9. The method of claim 6 wherein said specific properties include properties from the set of properties consisting of entry quantity, entry price, a first exit quantity, a first exit price, a second exit quantity, and a second exit price.

10. The method of claim 6 wherein said specific properties include properties from the set of properties consisting of entry quantity, entry price, a first exit quantity, a first exit price, a second exit quantity, a second exit price, and a stop price.

11. The method of claim 6 wherein the thing is a security traded through an exchange.

12. The method of claim 6 further comprising the step of recording said specific properties operated on by said one or more interface control elements into a memory.

13. The method of claim 12 further comprising the step of reading said specific properties from said memory and associating said read specific properties with a trade object.

14. The method of claim 13 further comprising the step of communicating said specific properties to a party authorized to aid in the transfer of the right interests in the thing.

15. The method of claim 6 further comprising the step of communicating said specific properties to a party authorized to aid in the transfer of the right interests in the thing.

16. The method of claim 6 wherein said interface control elements are selected from the group consisting of an entry order line, an exit order line, and a stop order line.

17. The method of claim 16 wherein said order lines have associated quantity labels that are responsive to said input/output control signals to effect changes in a quantity associated with one of said order lines.

18. The method of claim 18 wherein changes in one of said associated quantity labels are reflected in one or more of the other quantity labels associated with others of the order lines.

19. A method for executing a right transfer in a priced thing, comprising the steps of:
reading one or more values for one or more specific properties from a memory, said one or more specific properties associated with one or more properties of one or more trade objects for initiating an execution of the right transfer;
setting one or more of said interface control elements responsive to said one or more values, said interface control elements set associated with said one or more specific properties and with said interface control elements overlaid on a chart of time-varying price related data; and
initiating execution of the right transfer using the one or more trade objects when said time-varying price related data has a desired relationship to said properties.
